(19) United States
(12) Patent Application Publication
(10) Pub. No.: US 2007/0114228 A1
(43) Pub. Date: May 24, 2007

(54) Machine for producing and dispensing liquid and semi-liquid consumer food products

(76) Inventors: Gino Cocchi, Bologna (IT); Gianni Zaniboni, Borgonuovo Di Sasso Marconi (IT); Roberto Lazzarini, Reggio Emilia (IT)

Correspondence Address: Harbin King & Klima, 500 Ninth Street SE, Washington, DC, 20003, US

(21) Appl. No.: 11/602,217

(22) Filed: Nov. 21, 2006

(30) Foreign Application Priority Data
Nov. 22, 2005 (IT) BO2005A000704

(51) Int. Cl. H05B 6/64

(52) U.S. Cl. 219/679

(57) ABSTRACT

In a machine for producing and dispensing liquid and semi-liquid consumer food products, for example creams, sauces and ice creams, there is a container for the product and means for heating it, the heating means comprising an electromagnetic circuit, for example of the ohmic type, whose resistive component is the product itself.

### BACKGROUND OF THE INVENTION

The present invention relates to a machine for producing and dispensing liquid and semi-liquid consumer food products.

In particular, without limiting the scope of application, the present invention relates to pasteurizing machines, machines for cooking and preserving creams, jellies and sauces of various types, machines for producing and preserving ice cream, such as machines for “soft” ice cream, and similar products.

Machines of the type described above comprise a container or tank for the product processed, means for heating it, and if necessary for cooling it, and means for dispensing the product.

In order to make the temperature of the entire mass of product uniform during heating or cooling, there are also rotary stirring blades in the container.

In the prior art the heating means are of the resistive type and comprise an electric circuit which is closed as a spiral winding in the lateral walls and base wall of the container.

Heating means of this type are not only slow and uneven in their action, but also cause several disadvantages.

Firstly, if the container is not completely full the portion of its inner lateral surface above the level of the product assumes an extremely high temperature, with the consequent formation of crusts on it when it is hit by splashes caused by the action of the stirring blades.

Further disadvantages were found in the case in which the container must also house (for example in machines for producing ice cream) a cooling circuit, consisting of a pipe with a coolant flowing through it, made in the lateral walls and in the base wall of the container.

This limits the space available for the two circuits and means that their paths are extremely close together. As a result, the times for switching between the temperature reached during the heating step and a predetermined cooling temperature are extremely long due to the thermal inertia of the coolant pipe and of the container walls.

### SUMMARY OF THE INVENTION

The aim of the present invention is therefore to overcome the above-mentioned disadvantages.

Accordingly, the present invention achieves this aim with a machine for producing and dispensing liquid and semi-liquid consumer food products which has the characteristics described in one or more of the claims herein.

### BRIEF DESCRIPTION OF THE DRAWINGS

The technical features of the invention, in accordance with the afore-mentioned aims, are clearly indicated in the claims herein and the advantages of the invention are more apparent in the detailed description which follows, with reference to the accompanying drawings, which illustrate a preferred embodiment without limiting the scope of the invention, in which:

FIGS. 1 and 2 are schematic views of two embodiments of a machine for producing and dispensing liquid and semi-liquid food products in accordance with the present invention;

FIG. 3 is an enlarged cross-section of a detail of FIGS. 1 and 2;

FIG. 4 is a schematic perspective view of another embodiment of the machine in accordance with the present invention;

FIG. 5 is a schematic perspective view of another embodiment of the machine in accordance with the present invention;

FIG. 6 is a schematic side view of another embodiment of a detail of the machine in accordance with the present invention;

FIG. 7 is a schematic side view of another embodiment of a detail of the machine in accordance with the present invention.

### DESCRIPTION OF THE PREFERRED EMBODIMENTS

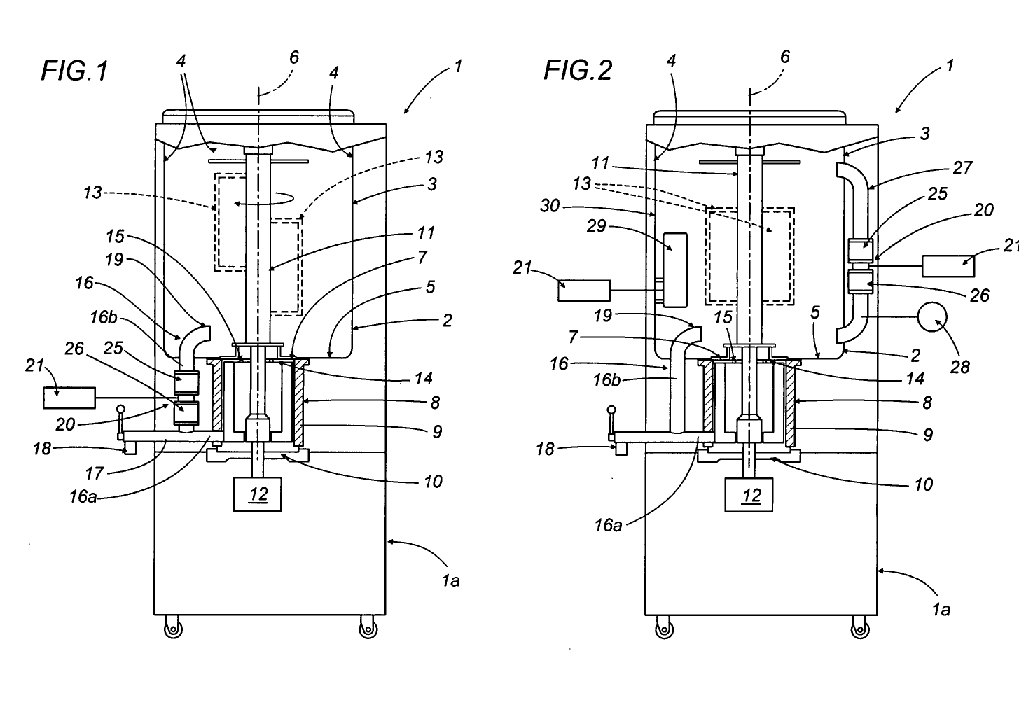

With reference to FIG. 1, the numeral 1 denotes as a whole a machine for producing and dispensing liquid and semi-liquid food products, for example a pasteurizing machine, for cooking and preserving creams and sauces of various types.

The machine 1 has a base 1a which substantially has the shape of a parallelepiped, inside which there is a container 2 for holding the product.

The container 2 comprises a tank 3 formed by vertical lateral walls 4 and a base wall 5, and it extends according to a vertical longitudinal axis labeled 6.

The container 2 also comprises, below the tank 3 and coaxial with it, at a circular opening 7 made in the base wall 5, a cylindrical chamber 8, formed by a cylindrical wall 9 and a base wall 10.

Passing through the cylindrical chamber 8 and its base wall 10 there is a rotary shaft 11 coaxial with the axis 6 and extending in the tank 3. The shaft 11 is motor-driven, at its lower end, by a motor schematically illustrated with a block 12 and the section of the shaft in the chamber 8, and when required, also the section of the shaft in the tank 3, supports blades 13, forming the product stirring means.

At the opening 7 there is a lid 14 with a central hole for the shaft 11 to pass through and holes 15 to allow communication between the chamber 8 and the tank 3.

The numeral 16 denotes a recirculating pipe connecting the chamber 8, through the cylindrical wall 9, and the tank 3, through the base wall 5.

The recirculating pipe 16 comprises a first, horizontal section 16a connected by a discharge pipe 17 to a dispensing nozzle 18 and a second, vertical section 16b, which has a curved end 19 in the tank 3.

As well as functioning as stirring means, the blades 13 provoke a flow of product along the pipe 16 and therefore product circulation (clockwise in FIG. 1) from the cylindrical chamber 8 to the tank 3.

The recirculating pipe 16, which as indicated is connected parallel with the container 2, at its vertical section 16b has means for heating the product, these means labeled 20 as a whole.

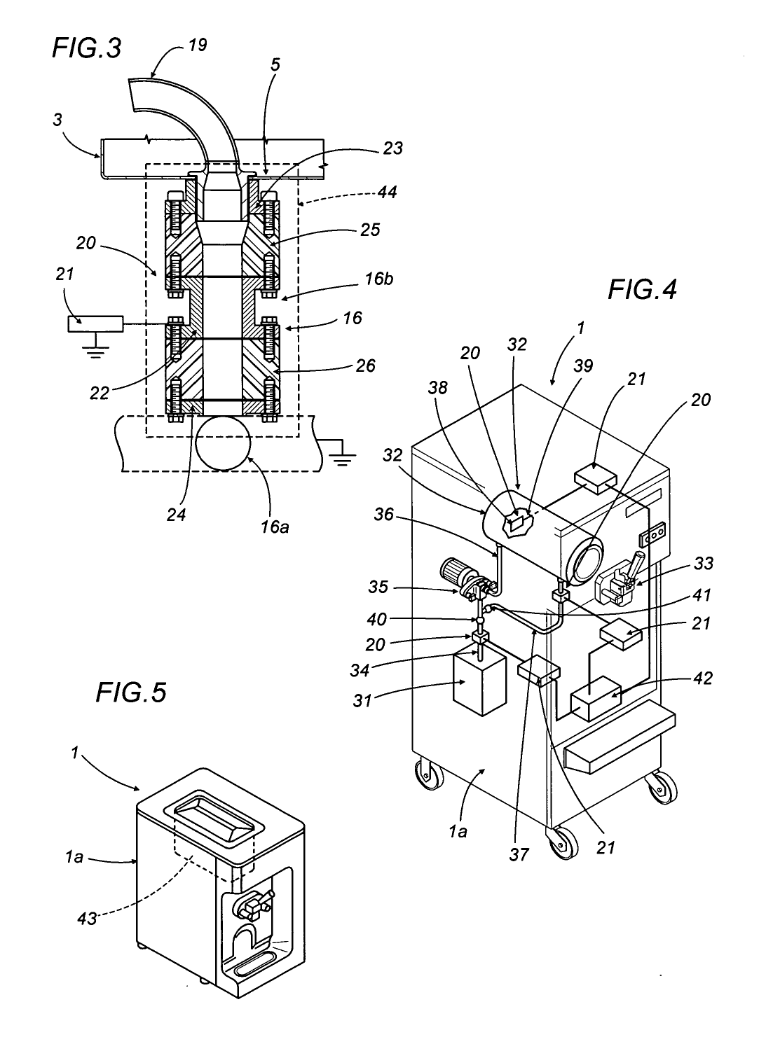

More precisely, with reference also to FIG. 3, the heating means comprise an electricity source schematically illustrated as a block 21, connected to a portion 22 of the section 16b made of a conducting material. The heating means 20 also comprise two more portions, upper 23 and lower 24 of the section 16b, also made of a conducting material, connected to the portion 22, with two portions 25 and 26 made of an insulating material in between.

Therefore, said portion 22 constitutes a first electrode and the portions 23 and 24 two second electrodes, which being in contact respectively with the base wall 5 of the tank 3 and the section 16a of the recirculating pipe 16 are earthed.

Therefore, the action of the electricity source 21 results in the generation of a difference in potential between the electrode 22 and the electrodes 23 and 24, with the consequent passage of electric current through the product which flows along the section 16b of the recirculating pipe 16. In this way an ohmic-type dynamic heating device is created, in which the resistive load consists of the product itself rather than an external resistance.

The machine 1 illustrated in FIG. 2 differs from the machine 1 in FIG. 1 due to the fact that the heating means 20 are not at the recirculating pipe 16, but at a pipe 27 extending parallel with the tank 3. In this case there may be a pump 28 able to make the product flow along the pipe 27.

Again as illustrated in FIG. 2, the heating means 20 may alternatively consist of a first electrode 29 in the tank 3 and a second electrode 30 coinciding with the tank 3 itself. In this case, unlike the one previously described, the heating device is of the static type.

FIG. 4 shows a machine for producing ice cream of the so-called “soft” type. The numeral 31 denotes the container for the liquid product used to obtain the ice cream and 32 denotes means for transforming the liquid product, comprising a “whipping and freezing” unit consisting of a cylindrical freezing container inside which there is a stirrer and connected to a refrigerating unit, of the known type and not illustrated. In the front part of the cylinder there is a tap 33 for extracting the ice cream.

The numeral 34 denotes an outfeed pipe from the container 31 connected, by a pump 35 and an infeed pipe 36, to the cylinder 32 and the numeral 37 denotes a recirculating pipe which connects the cylinder 32 to the pipe 34 immediately upstream of the pump 35.

The machine in FIG. 4 also has heating means, labeled 20 as a whole, for heat-treating the product before each ice cream production cycle and also at the end of each cycle, so as to guarantee product preservation.

These heating means 20, of the type illustrated in FIG. 3, may be positioned along the outfeed pipe 34, along the recirculating pipe 37 and, as illustrated in the alternative embodiment in FIG. 2, they may be of the static type, that is to say having a first electrode 38 in the cylinder 32 and a second electrode 39 coinciding with a wall of the cylinder 32 itself.

The numeral 40 denotes a valve along the pipe 34 and inserted between the heating means 20 and the recirculating pipe 37 opening point; whilst 41 denotes a valve along the pipe 37. The numeral 21 denotes the electricity sources all controlled by a central control unit illustrated with a block 42.

It should be noticed that the heating means 20 may operate in combination with one another or separately.

Finally, FIG. 5 shows a machine 1 for producing “soft” ice cream, which differs from the machine 1 in FIG. 4 in that it has a tank 43 in place of the container 31.

It should also be noticed that the heating means 20 may consist of a KIT unit 44, which can be associated with the machine 1 using quick coupling—release means. For example, the KIT unit may be made as illustrated in FIG. 3, and may be inserted, for example, along the vertical section 16b of the recirculating pipe 16.

The KIT 44 may be produced and sold separately from the machine 1 and may also be mounted on existing machines.

Finally, it should be noticed that, in accordance with the present invention, the heating means 20 do not consist of external electric heating elements, wound in a spiral in the lateral walls or the base wall of the container, but of electromagnetic means operating directly on the product accumulated in the tank or flowing along a pipe, causing an electric current to flow through the product, heating it rapidly and evenly.

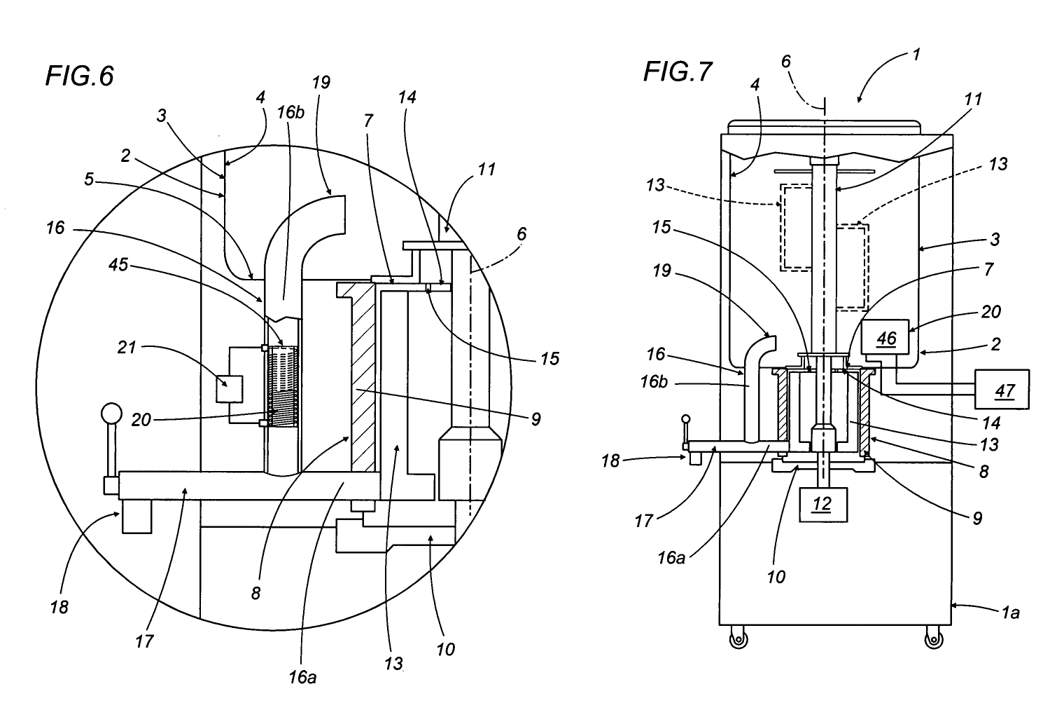

As illustrated in FIG. 6, the heating means 20 may be of the inductive type and comprise an induction winding 45 positioned for example in the recirculating pipe 16. Said winding 45, connected to a generator of alternating current at a predetermined frequency 21, by mutual inductance generates a magnetic field and therefore an electric current through the secondary, consisting of the product, which is heated as a result.

Finally, as shown in FIG. 7, the heating means 20 may comprise a microwave generator 46 powered by a power source 47 and positioned, for example, in the chamber 8 and acting directly on the product.

The electromagnetic wave generator 46 can operate in the radio frequency range.

The invention described has evident industrial applications and may be modified and adapted without thereby departing from the scope of the inventive concept. Moreover, all details of the invention may be substituted by technically equivalent elements.

1. A machine for producing and dispensing liquid and semi-liquid consumer food products, comprising a container for the product, means for heating the product, wherein the heating means comprise electromagnetic means operating directly on the product.

2. The machine according to claim 1, wherein the heating means comprise an ohmic-type electric circuit whose resistive component is the product.

3. The machine according to claim 1, wherein the heating means comprise an inductive-type circuit wherein the secondary is the product.

4. The machine according to claim 1, wherein the heating means comprise a microwave generator acting directly on the product.

5. The machine according to claim 1, wherein the heating means comprise a generator of electromagnetic waves in the radio frequency range.

6. The machine according to claim 1, wherein the electromagnetic means are positioned along a pipe connected to the container.

7. The machine according to claim 1, wherein the electromagnetic means are positioned along a pipe connected parallel with the container.

8. The machine according to claim 1, wherein the electromagnetic means are positioned at least partly in the container.

9. The machine according to claim 6, wherein the electromagnetic means comprise at least two electrodes positioned along the pipe, one of them being connected to a current generator.

10. The machine according to claim 8, wherein the electromagnetic means comprise at least one electrode located in the container and connected to a current generator.

11. The machine according to claim 6, wherein the heating means comprise an electric winding positioned close to the product and designed to generate an electromagnetic field able to induce the passage of an electric current on the product.

12. The machine according to claim 1, wherein the container comprises a tank and below the tank a chamber connected to the tank by a recirculating pipe forming the pipe connected parallel with the container.

13. The machine according to claim 1, also comprising means for transforming the product, wherein the heating means are positioned along a pipe for feeding the product to the transforming means.

14. The machine according to claim 1, also comprising means for transforming the product, wherein the heating means are positioned along a pipe positioned parallel with the transforming means or inside them.

15. The machine according to claim 1, wherein the heating means consist of a unit which can be associated with the machine using quick coupling—release means.

16. The machine according to claim 5, wherein the electromagnetic means are positioned along a pipe connected to the container.

17. The machine according to claim 5, wherein the electromagnetic means are positioned along a pipe connected parallel with the container.

18. The machine according to claim 5, wherein the electromagnetic means are positioned at least partly in the container.

19. The machine according to claim 7, wherein the electromagnetic means comprise at least two electrodes positioned along the pipe, one of them being connected to a current generator.

20. The machine according to claim 7, wherein the heating means comprise an electric winding positioned close to the product and designed to generate an electromagnetic field able to induce the passage of an electric current on the product.
